(19) United States
(12) Patent Application Publication
(10) Pub. No.: US 2014/0012690 A1
(43) Pub. Date: Jan. 9, 2014

(54) Systems and Methods for Facilitating Cash-Based Transactions

(71) Applicants: Stephen P. Capps, San Carlos, CA (US); Michael Tibbott, Mountain View, CA (US); Kurt Thams, Santa Cruz, CA (US); Richard Scott Perkins, Meridian, ID (US); John Paul Minor, Brick, NJ (US); Craig Carper, Mountain View, CA (US)

(72) Inventors: Stephen P. Capps, San Carlos, CA (US); Michael Tibbott, Mountain View, CA (US); Kurt Thams, Santa Cruz, CA (US); Richard Scott Perkins, Meridian, ID (US); John Paul Minor, Brick, NJ (US); Craig Carper, Mountain View, CA (US)

(73) Assignee: PayNearMe, Inc.

(21) Appl. No.: 13/542,374

(22) Filed: Jul. 5, 2012

(51) Int. Cl. G06Q 20/20

(52) U.S. Cl. CPC G06Q 20/202
USPC 705/21

(57) ABSTRACT

Disclosed herein are systems and method for facilitating transactions between a merchant-partner and an end-user (e.g., a customer of the merchant-partner). More specifically, presented herein are pricing systems and methods for establishing and staging transactions between a point-of-sale terminal, one or more merchant-partners, and a service provider.

### SUMMARY

Disclosed herein are systems and methods for facilitating transactions between a merchant-partner and an end-user (e.g., a customer of the merchant-partner). More specifically, presented herein are systems and methods for establishing, staging, and settling transactions between a point-of-sale terminal, one or more merchant-partners, and a service provider. In one embodiment, for example, the systems and methods generally include: (a) providing the merchant-partner with an interface to select and/or define a settlement funding model and/or a pricing model; (b) staging a transaction between the merchant-partner and the end-user, wherein the staging of the transaction includes calculating a transaction price based on the pricing model; (c) receiving presentment data from the POS terminal indicating that the end-user has presented, to the POS terminal, a payment for the merchant-partner; (d) using the presentment data to confirm that the payment is in accordance with the staged transaction between the end-user and the merchant-partner; and (e) generating an outbound cash-flow to the merchant-partner to settle the transaction based on the settlement funding model.

Aspects of the present invention are particularly useful in providing merchants (e.g., web-based or catalog-based merchants) with a means for conducting fast, easy, and secure cash transactions with consumers. The present invention is also particularly useful in facilitating cash transactions such as: loan repayments, collections, money transfers, bill payments, remote deposits, etc.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level flow process chart illustrating the relationships between the parties that partake in the presented systems and methods.

FIG. 2 is a high-level flowchart illustrating a method for facilitating transactions, in accordance with one embodiment presented herein.

FIG. 3 is a high-level process chart illustrating one aspect of the present invention.

FIG. 4 is a high-level process chart illustrating one aspect of the present invention.

FIG. 5 is a schematic drawing of a computer system used to implement the methods presented herein.

### DETAILED DESCRIPTION

The present application is related to co-pending and co-owned U.S. application Ser. Nos. 13/123,067; 13/087,271; and 13/175,657, filed Apr. 7, 2011; Apr. 14, 2011; and Jul. 1, 2011, respectively; the disclosures of which are herein incorporated by reference in their entirety. For example, U.S. application Ser. No. 13/087,271 discloses systems and methods that generally include: (a) staging a transaction between a merchant and a customer; (b) tokenizing the transaction by linking one or more transaction instructions to a token ID; (c) providing the customer with the token ID, wherein the customer can then present the token ID and a payment to a point-of-sale (POS) terminal; (d) receiving confirmation that the customer has presented, to the POS terminal, the token ID and a payment in accordance with the one or more transaction instructions; (e) notifying the merchant that the customer provided the payment to the POS terminal; and (f) settling the transaction between the POS terminal and the merchant. The systems and methods presented herein expand on and further develop the processes presented in U.S. application Ser. Nos. 13/123,067 and 13/087,271.

Before describing the invention in more detail, it is appropriate to define certain terms and phrases. The terms “merchant” and “merchant-partner” are used interchangeably herein. It is noted that the term “merchant” and/or “merchant-partner” is not limited to entities that directly sell goods/services. For example, a merchant may be a loan service, collections service, money transfer service, bill payment service, bank deposit service, credit union, etc. The terms “consumer,” “customer,” and “end-user” are used interchangeably herein. However, it is noted that the use of the systems and methods presented is not limited to sale/purchase transactions between a seller and a buyer. The systems and methods presented may be used to facilitate transactions between: two individuals, an individual and a business, two businesses, etc. The systems and methods presented may also be used to facilitate transactions between any two parties that have a pre-existing relationship or obligation(s). The terms “point-of-sale,” “point-of-sale terminal,” “POS,” “POS terminal,” and “point-of-payment” are used interchangeably herein. It is also noted that terms such as “POS” or “POS terminal” may include the actual terminal where payment is presented and received (e.g., the cash register), or may include the POS back office or any entity controlling one or more of the actual terminals. The terms “service provider” and “payment processor” are used interchangeably herein.

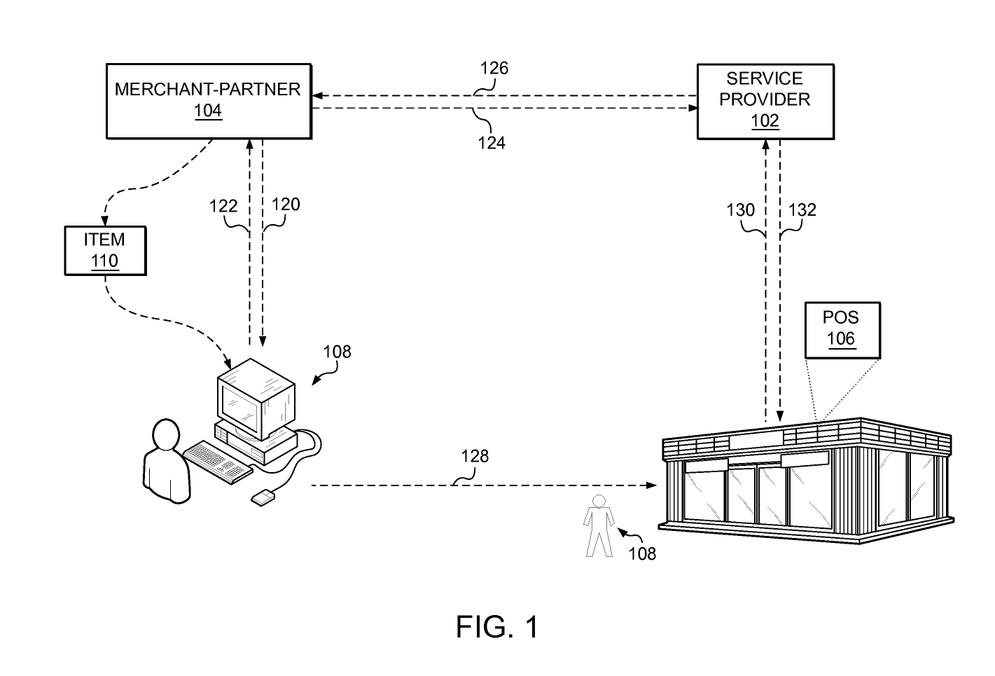

The following is a description of one or more embodiments of the present invention, with reference to FIGS. 1-5. It is to be understood that the present invention is not limited to the particular embodiments described. It is also to be understood that the terminology used herein is for the purpose of describing particular embodiments only, and is not intended to be limiting, since the scope of the present invention will be limited only by the appended claims.

In one embodiment, a service provider and/or POS terminal serves as an intermediary between a merchant-partner and the customer. The system allows the customer to pay for the merchant-partner's goods/services in cash (or cash equivalents) at a POS terminal. The POS terminal and/or service provider then notifies the merchant that the customer has made a payment. After the merchant-partner has received a notification, validation, or otherwise confirmation of payment, the merchant-partner can securely complete the agreed upon transaction between the merchant-partner and the customer.

However, in order for such system to be commercially viable, the systems and methods presented generally include the process steps of: (a) staging a transaction between the merchant and the customer; (b) tokenizing the transaction by linking one or more transaction instructions to a token ID; (c) providing the customer with the token ID, wherein the customer can then present the token ID and a payment to a POS terminal; (d) receiving confirmation that the customer has presented, to a POS terminal, the token ID and a payment in accordance with the one or more transaction instructions; (e) notifying the merchant that the customer provided the payment to the POS terminal; and (f) settling the transaction between the POS terminal and the merchant.

FIG. 1 is a high-level flow process chart, illustrating the relationships between the parties that partake in the presented system 100. In general, system 100 includes four key parties: (1) service provider 102; (2) merchant-partner 104; (3) point-of-sale (POS) 106; and (4) end-user 108. The dashed lines in FIG. 1 generally represent a flow of information, data, or process between respective parties. In practice, the dashed lines in FIG. 1 represent user interfaces and/or application program interfaces (APIs) for the transmission of information, data, instructions, funds, etc.

As will be described further below, service provider 102 and POS 106 play a central role in facilitating transactions between merchant-partner 104 and end-user 108.

In one embodiment, each party serves a stand-alone function within system 100. However, in an alternative embodiment, service provider 102 may be incorporated into, or be a functional unit of, merchant-partner 104 and/or POS 106. Further, merchant-partner 104 may be any type of merchant, seller, or retailer; such as an online, web-based merchant, or catalog-based merchant. POS 106 may be a local retailer (e.g., relative to end-user 108), ATM, kiosk, or other cash-exchange terminal, intermediary, or equivalent thereof.

In FIG. 1, process flow 120 and 122 represents an exchange between merchant-partner 104 and end-user 108. In the example shown, merchant-partner 104 provides end-user 108 with a user-interface to purchase a goods/services. For example, the merchant may provide the user with a “checkout” experience over: a webpage on a merchant's website; an interface on a mobile device; an interactive voice system over a telephone network; or any interface equivalent thereto. While known customer user-interfaces may provide a “checkout” experience that allows an end-user to enter their credit card information, the system shown in FIG. 1 provides the end-user with a checkout experience that allows the end-user to pay for the goods/services in cash (or cash equivalents).

If the end-user selects to pay in cash, then merchant-partner 104 interfaces and exchanges information with service provider 102, as represented by process flow 124, 126. In practice, merchant-partner 104 and/or service provider 102 stages a transaction by linking a set of one or more transaction instructions to end-user 108. The transaction instructions may vary, but generally include instructions on what actions (e.g., payments) need to be performed by end-user 108 in order for merchant-partner 104 to provide end-user 108 with the agreed upon goods/services (e.g., item 110). The transaction instructions may include actions to be performed by the end-user 108, merchant-partner 104, service provider 102, or any combination thereof.

Service provider 102 then “tokenizes” the staged transaction by linking the set of one or more transaction instructions to a token ID. (The terms “token,” “token ID,” “unique payment identifier,” and “PID” are used interchangeably herein.) In an alternative embodiment, a single token ID can be linked to multiple staged transactions and/or multiple merchant-partners. The token ID is then provided to end-user 108. The token ID can be provided to the end-user 108 either directly from service provider 102, or via POS 106 or merchant-partner 104. When end-user 108 is ready to make a payment, end-user 108 presents the token ID to POS 106, along with an appropriate payment, as represented by process flow 128. At POS 106, the token ID serves as a means of linking the end-user's payment to the one or more transaction instructions.

In an alternative embodiment, the systems and methods described herein do not require merchant-partner 104 to provide end-user 108 with a checkout experience. There is also no requirement that the end-user provide an intent or selection of a cash payment option. For example, in one embodiment, merchant-partner 104 provides its customers with one or more tokens as a means for the customers to make payments. The payments can be made at a POS terminal, and a series of staged transactions may proceed, without any front-end involvement by the end-user.

When end-user 108 presents the token ID and payment to POS 106, the token ID is used to route the presentment information to service provider 102, as represented by process flow 130, 132. Service provider 102 may then validate that the presentment was in accordance with the transaction instructions linked to the token ID. If the end-user's payment is in accordance with the transaction instructions linked to the token ID, then service provider 102 notifies merchant-partner 104 that a payment has been made. Merchant-partner 104 then completes the transaction by, for example, shipping item 110 or otherwise fulfilling the transaction and/or crediting end-user's 108 account with merchant-partner 104. Service provider 102 then settles the transaction between merchant-partner 104 and POS 106 by receiving the payment funds (minus any agreed upon service fees) from POS 106, and delivering the payment funds (minus any agreed upon service fees) to merchant-partner 104.

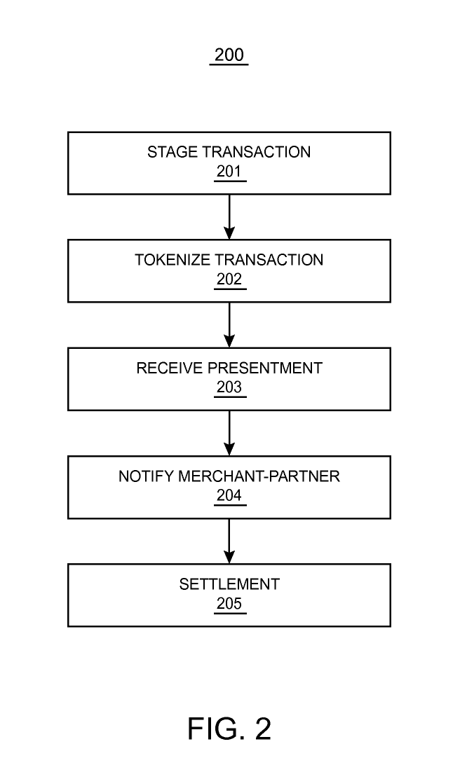

FIG. 2 is a high-level flowchart illustrating a method 200 for facilitating a transaction between a merchant and a customer, in accordance with one embodiment presented herein. More specifically, FIG. 2 is a flowchart generally illustrating the steps performed in the system described in FIG. 1. The method includes: (a) staging a transaction (step 201); (b) tokenizing the staged transaction (step 202); (c) receiving the presentment (step 203); (d) notifying the merchant-partner that the presentment has been received (step 204); and (e) settling the transaction between the parties (step 205). Additional details for steps (a)-(d) are provided in U.S. application Ser. Nos. 13/123,067 and 13/087,271.

The systems and methods disclosed herein expand on the above presented systems and methods by providing customizable features for the participating merchant-partners, in a scalable and commercially viable manner. More specifically, the systems and methods presented are used for establishing, staging, and settling transactions between a point-of-sale terminal, one or more merchant-partners, and a service provider. Embodiments generally include: (a) providing the merchant-partner with an interface such that the merchant-partner can select and/or define a settlement funding model and/or a pricing model. The interface may be a graphical user interface (GUI), an application programming interface (API), or any equivalent interface for sending and/or receiving instructions between the parties. Embodiments further include: (b) staging transactions based on the pricing model; (c) receiving confirmation that the end-user has presented a payment at a POS terminal; and (d) settling the transaction with the merchant-partner. The staging and settling steps may be based on the pricing model and/or settlement funding model selected by the merchant-partner, a service provider, or any third-party. The staging and/or settling steps may also be time- or event-dependent, such that the staging and/or settling steps are updated in real-time to reflect changes in the selected or defined pricing and/or settlement funding models.

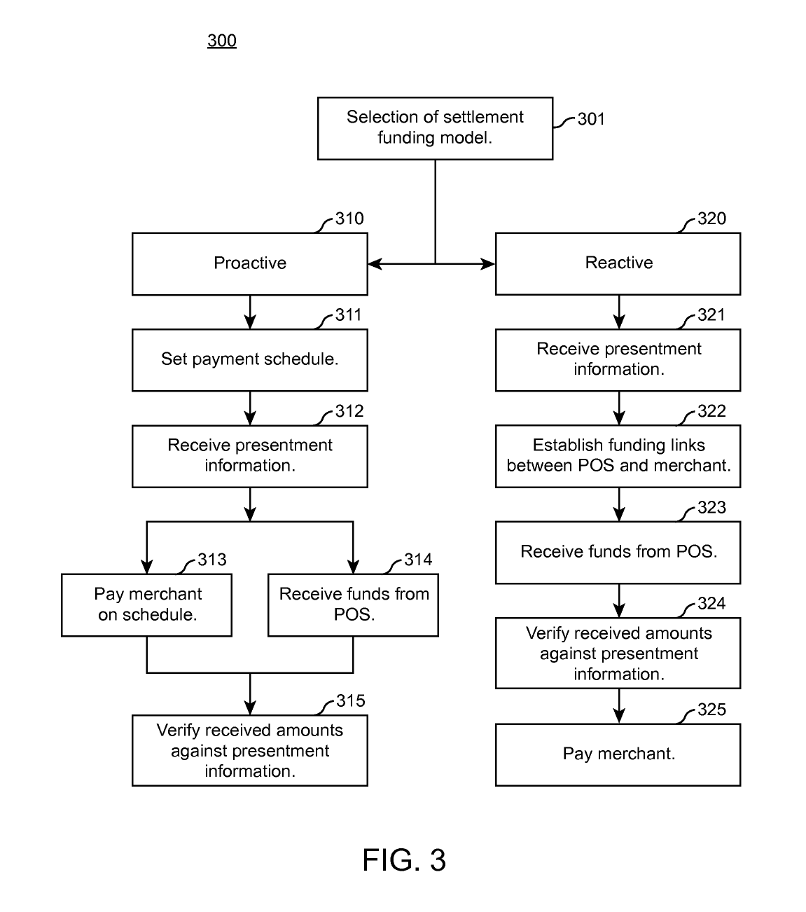

FIG. 3 is a high-level process chart illustrating the process of selecting a settlement model. In step 301, the merchant-partner is provided with an interface (e.g., a GUI, API, telephone prompt, mobile application prompt, web-based prompt, etc.) to select a settlement funding model. While various models are possible, FIG. 3 illustrates the differences between a “proactive” model 310 and a “reactive” model 320. A proactive model 310 is characterized by having a set (i.e., predictable) payment schedule. If the merchant-partner selects a proactive model, then in step 311 the merchant-partner may also be asked to set the payment schedule (i.e., identify when they wish to receive settlement funds after presentment of payment has been made at the POS terminal). A proactive model may also include expedited vs. non-expedited payments. For expedited payments, the merchant-partner may wish to receive settlement funds prior to the payment being processed and/or received by the service provider. As such, the merchant-partner may be “floated” settlement funds. Based on the number of float days, the service provider's processing unit can automatically adjust any service fees charged to (or collect from) the merchant-partner. Under the proactive model, when the service provider receives presentment information from the POS terminal, indicating that the payment has been received at the POS terminal, in step 312, the service provider pays the merchant-partner in accordance with the set schedule, in step 313. Settlement payments by the service provider are conducted regardless of whether the funds have been pushed up from the POS terminal to the service provider. When the funds are finally received by the service provider, from the POS terminal, in step 314, the service provider can confirm/verify that the received funds match the amounts expected based on the presentment information (or staging instructions), in step 315.

If the merchant-partner selects a reactive model 320, then settlement funds are provided to the merchant-partner only after they are received and processed by the service provider. Under a reactive model, funding links (e.g., actual bank accounts, partitions in accounts, or simply database matching) can be established between the POS terminal and the merchant-partner, in step 322, before or after the receipt of presentment information, in step 321. When the funds are received by the service provider, from the POS terminal, in step 323, the service provider verifies the received amounts against the presentment information (or staged transaction), in step 324. If the received amounts match the expected amounts, the merchant-partner can then be paid by the service provider, in step 325.

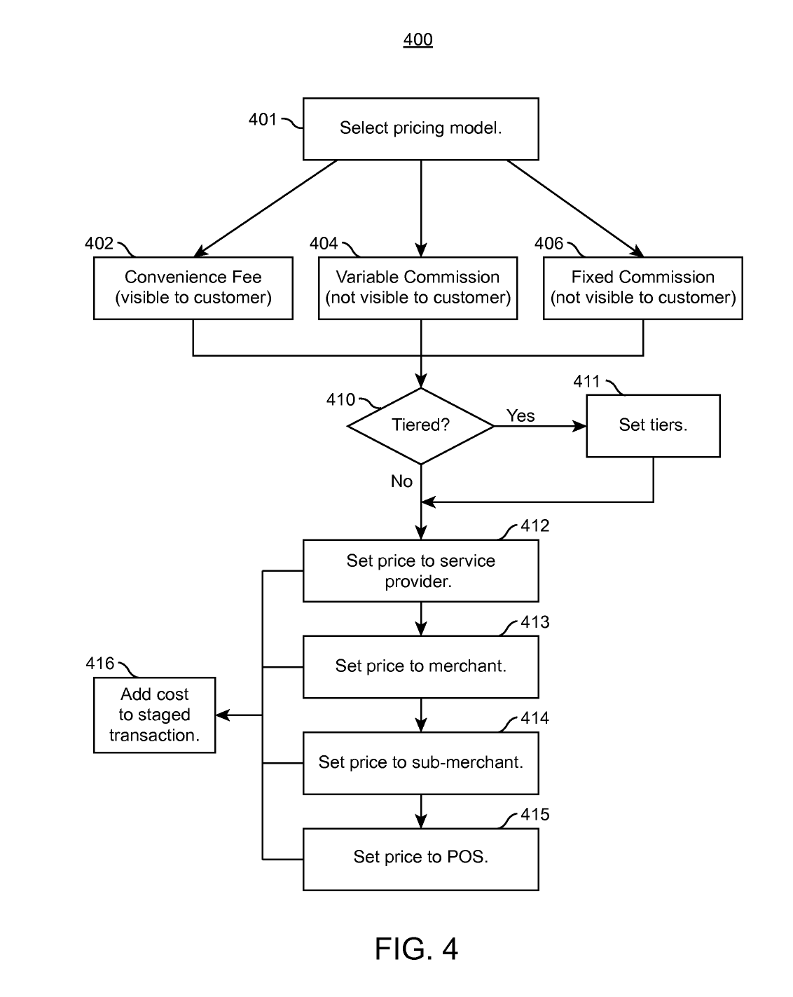

FIG. 4 is a high-level process chart illustrating example pricing models that may be selected by the merchant-partner. Such pricing models establish the price/cost relationship between the parties partaking in the present invention (i.e., the service provider, merchant-partner(s), and/or POS). For example, in step 401, the merchant-partner is provided an interface (e.g., a GUI, API, telephone prompt, mobile application prompt, web-based prompt, etc.) to select a pricing model. While various pricing models are possible, FIG. 4 illustrates three example pricing models: a convenience fee 402; a variable commission 404; and a fixed commission. The merchant-partner can select or define individual pricing models, or a combination of the presented pricing models.

A convenience fee model 402 is typically visible to the customer (i.e., end-user). In a convenience fee model, the customer generally pays any extra costs for the convenience of conducting the transaction. A variable commission model 404 is typically not shown to the customer. In a variable commission model, costs are typically incurred by the merchant-partner. Variable commission can be established between one or more parties, and dependent on one or more factors. For example, a variable commission structure may call for percentages being paid by/to the merchant-partner; sub-units below the merchant-partner; and/or the POS terminal. A fixed commission model 406 is also typically not shown to the customer. In a fixed commission model, the costs are also typically incurred by the merchant-partner. Fixed commission can be established and/or attributed to one or more parties, and dependent on one or more factors. For example, a fixed commission structure may call for percentages being paid by/to the merchant-partner; sub-units below the merchant-partner; and/or the POS terminal. Each pricing model can also be tiered, in steps 410 and 411, in order to modify the prices/costs for service based on the transaction amount. As such, in steps 412-415, the price for the transaction (or transaction tier) is set for the service provider, merchant-partner, sub-units of the merchant-partner, and/or POS terminal. In step 416, the set prices are used to add the costs to the staged transaction. As such, the presented systems and methods provide a scalable and automated way of allowing a merchant-partner to customize their settlement and pricing experience according to their needs and expectations.

### Additional Embodiments

In another embodiment, there is provided a computer-implemented method for facilitating a transaction between an end-user and a merchant-partner, wherein a point-of-sale (POS) terminal receives presentment of a payment from an end-user for the merchant-partner. The method comprises a service provider processing system performing the steps of: (a) providing the merchant-partner with an interface such that the merchant-partner can define a settlement funding model and a pricing model; (b) staging a transaction between the merchant-partner and the end-user, wherein the staging of the transaction includes calculating a transaction price based on the pricing model; (c) receiving presentment data from the POS terminal indicating that the end-user has presented, to the POS terminal, a payment for the merchant-partner; (d) using the presentment data to confirm that the payment is in accordance with the staged transaction between the end-user and the merchant-partner; and (e) generating an outbound cash-flow to the merchant-partner to settle the transaction based on the settlement funding model. The settlement funding model may be selected from the group consisting of: a proactive funding model and a reactive funding model. The settlement funding model and/or pricing model may be reconfirmed at the point of presentment at the POS terminal. If the merchant-partner selects a proactive funding model, the method may further comprise: after step (e), the service provider processing system (f) creating a funding record identifying a funding amount expected to be received from the POS terminal; and (g) confirming that funds received from the POS terminal match the funding amount expected from step (f). If the merchant-partner selects a proactive funding model, the method may further comprise: in step (a), the service provider processing system providing an interface such that the merchant-partner can define a settlement schedule; in step (b), the service provider processing system including the settlement schedule as a data field in the staged transaction; and the service provider processing system performing step (e) on the settlement schedule. If the merchant-partner selects a reactive funding model, the method may further comprise: after step (d), but prior to step (e), the service provider processing system (1) creating a funding record identifying a funding amount expected to be received from the POS terminal; and (2) confirming that funds received from the POS terminal match the funding amount expected from step (1). The pricing model may be selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof. The method may further comprise: after step (d), but prior to step (e), the service provider processing system authorizing the POS terminal to accept the payment from the end-user.

In another embodiment, there is provide a computer-implemented method for facilitating a transaction between an end-user and a merchant-partner, wherein a point-of-sale (POS) terminal receives presentment of a payment from an end-user for the merchant-partner. The method comprises a service provider processing system performing the steps of: (a) providing the merchant-partner with a graphical user interface such that the merchant-partner can select a settlement funding model and a pricing model; (b) staging a transaction between the merchant-partner and the end-user, wherein the staging of the transaction includes calculating a transaction price based on the pricing model selected by the merchant-partner; (c) receiving presentment data from the POS terminal indicating that the end-user has presented, to the POS terminal, a payment for the merchant-partner; (d) using the presentment data to confirm that the payment is in accordance with the staged transaction between the end-user and the merchant-partner; and (e) generating an outbound cash-flow to the merchant-partner to settle the transaction based on the settlement funding model selected by the merchant-partner. The settlement funding model may be selected from the group consisting of: a proactive funding model and a reactive funding model. If the merchant-partner selects a proactive funding model, then after step (e), the service provider processing system can perform the steps of: (f) creating a funding record identifying a funding amount expected to be received from the POS terminal; and (g) confirming that funds received from the POS terminal match the funding amount expected from step (f). If the merchant-partner selects a proactive funding model, the service provider processing system can perform the steps of: providing a graphical user interface such that the merchant-partner can select a number of float days, in step (a); including the number of float days as a data field in the staged transaction, in step (b); and performing step (e) after completion of the number of float days selected by the merchant-partner. If the merchant-partner selects a reactive funding model, then after step (d), but prior to step (e), the service provider processing system can perform the steps of: (1) creating a funding record identifying a funding amount expected to be received from the POS terminal; (2) confirming that funds received from the POS terminal match the funding amount expected from step (1); and/or (3) authorizing the POS terminal to accept the payment from the end-user.

The pricing model may be selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof.

In yet another embodiment, there is provided a computer-implemented system for facilitating a transaction between an end-user and a merchant-partner, wherein a point-of-sale (POS) terminal receives presentment of a payment from an end-user for the merchant-partner. The system comprises: (a) means for providing the merchant-partner with a graphical user interface such that the merchant-partner can select a settlement funding model and a pricing model; (b) means for staging a transaction between the merchant-partner and the end-user, wherein the staging of the transaction includes calculating a transaction price based on the pricing model selected by the merchant-partner; (c) means for receiving presentment data from the POS terminal indicating that the end-user has presented, to the POS terminal, a payment for the merchant-partner; (d) means for using the presentment data to confirm that the payment is in accordance with the staged transaction between the end-user and the merchant-partner; and (e) means for generating an outbound cash-flow to the merchant-partner to settle the transaction based on the settlement funding model selected by the merchant-partner. The settlement funding model may be selected from the group consisting of: a proactive funding model and a reactive funding model. The pricing model may be selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof.

If the merchant-partner selects a proactive funding model, the system may further comprise: means for providing a graphical user interface such that the merchant-partner can select a number of float days; means for including the number of float days as a data field in the staged transaction; and/or means for generating the outbound cash-flow after completion of the number of float days selected by the merchant-partner. The system may further comprise: means for creating a funding record identifying a funding amount expected to be received from the POS terminal; means for confirming that funds received from the POS terminal match the funding amount expected; means for authorizing the POS terminal to accept the payment from the end-user; and/or means for tokenizing the trans action.

In still another embodiment, there is provided a computer-implemented system for facilitating a transaction between an end-user and a merchant-partner, wherein a point-of-sale (POS) terminal receives presentment of a payment from an end-user for the merchant-partner. The system comprises: (a) means for providing the merchant-partner with an interface such that the merchant-partner can set a settlement funding model and a pricing model; (b) means for staging a transaction between the merchant-partner and the end-user, wherein the staging of the transaction includes calculating a transaction price based on the pricing model; (c) means for receiving presentment data from the POS terminal indicating that the end-user has presented, to the POS terminal, a payment for the merchant-partner; (d) means for using the presentment data to confirm that the payment is in accordance with the staged transaction between the end-user and the merchant-partner; and (e) means for generating an outbound cash-flow to the merchant-partner to settle the transaction based on the settlement funding model. The settlement funding model may be selected from the group consisting of: a proactive funding model and a reactive funding model. The pricing model is selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof. The system may further comprise: (f) means for confirming the pricing model and/or settlement funding model at the point of presentment; (g) means for providing an interface such that the merchant-partner can set a settlement schedule; (h) means for including the settlement schedule as a data field in the staged transaction; (i) means for generating the outbound cash-flow in accordance with the settlement schedule; (j) means for creating a funding record identifying a funding amount expected to be received from the POS terminal; (k) means for confirming that funds received from the POS terminal match the funding amount expected; (1) means for authorizing the POS terminal to accept the payment from the end-user; and/or (m) means for tokenizing the transaction.

### Computer Implementation.

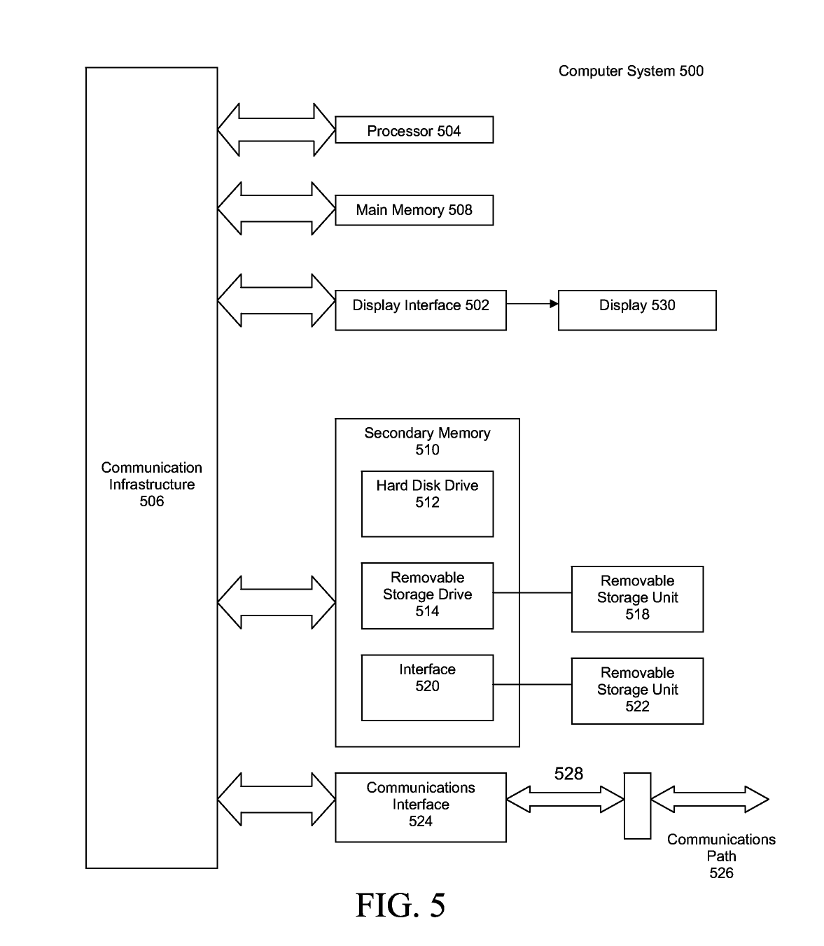

In one embodiment, the invention is directed toward one or more computer systems capable of carrying out the functionality described herein. For example, FIG. 5 is a schematic drawing of a computer system 500 used to implement the methods presented above. Computer system 500 includes one or more processors, such as processor 504. The processor 504 is connected to a communication infrastructure 506 (e.g., a communications bus, cross-over bar, or network). Computer system 500 can include a display interface 502 that forwards graphics, text, and other data from the communication infrastructure 506 (or from a frame buffer not shown) for display on a local or remote display unit 530.

Computer system 500 also includes a main memory 508, such as random access memory (RAM), and may also include a secondary memory 510. The secondary memory 510 may include, for example, a hard disk drive 512 and/or a removable storage drive 514, representing a floppy disk drive, a magnetic tape drive, an optical disk drive, flash memory device, etc. The removable storage drive 514 reads from and/or writes to a removable storage unit 518. Removable storage unit 518 represents a floppy disk, magnetic tape, optical disk, flash memory device, etc., which is read by and written to by removable storage drive 514. As will be appreciated, the removable storage unit 518 includes a computer usable storage medium having stored therein computer software, instructions, and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow computer software, instructions, and/or data to be transferred from the removable storage unit 522 to computer system 500.

Computer system 500 may also include a communications interface 524. Communications interface 524 allows computer software, instructions, and/or data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 514, removable storage units 518, 522, data transmitted via communications interface 524, and/or a hard disk installed in hard disk drive 512. These computer program products provide computer software, instructions, and/or data to computer system 500. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the presented methods. Accordingly, such computer programs represent controllers of the computer system 500. Where appropriate, the processor 504, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 500 using removable storage drive 514, interface 520, hard drive 512, or communications interface 524. The control logic (software), when executed by the processor 504, causes the processor 504 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) provide a merchant-partner with a graphical user interface such that the merchant-partner can select a settlement funding model and a pricing model; (b) stage a transaction between the merchant-partner and an end-user, wherein the staging of the transaction includes calculating a transaction price based on the pricing model selected by the merchant-partner; (c) receive presentment data from a POS terminal indicating that the end-user has presented, to the POS terminal, a payment for the merchant-partner; (d) use the presentment data to confirm that the payment is in accordance with the staged transaction between the end-user and the merchant-partner; and (e) generate an outbound cash-flow to the merchant-partner to settle the transaction based on the settlement funding model selected by the merchant-partner.

The computer-readable storage medium may further comprise instructions executable by at least one processing device that, when executed, cause the processing device to: (f) provide a graphical user interface such that the merchant-partner can select a number of float days; (g) generate the outbound cash-flow after completion of the number of float days selected by the merchant-partner; (h) create a funding record identifying a funding amount expected to be received from the POS terminal; (i) confirm that funds received from the POS terminal match the funding amount expected; (j) authorize the POS terminal to accept the payment from the end-user; and/or (k) tokenize the trans action.

The settlement funding model may be selected from the group consisting of: a proactive funding model and a reactive funding model. The pricing model may be selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof.

In another embodiment, there is provided a computer-readable storage medium, comprising instructions, executable by at least one processing device that, when executed, cause the processing device to: (a) provide a merchant-partner with an interface such that the merchant-partner can set a settlement funding model and a pricing model; (b) stage a transaction between the merchant-partner and an end-user, wherein the staging of the transaction includes calculating a transaction price based on the pricing model; (c) receive presentment data from a POS terminal indicating that the end-user has presented, to the POS terminal, a payment for the merchant-partner; (d) use the presentment data to confirm that the payment is in accordance with the staged transaction between the end-user and the merchant-partner; and (e) generate an outbound cash-flow to the merchant-partner to settle the transaction based on the settlement funding model. The computer-readable storage medium may further include instructions to confirm the settlement funding model and/or pricing model in place at the time of presentment. The computer-readable storage medium may further comprise instructions that, when executed, cause the processing device to: provide an interface such that the merchant-partner can set a settlement schedule; and generate the outbound cash-flow in accordance with the settlement schedule. The computer-readable storage may further comprise instructions that, when executed, cause the processing device to: create a funding record identifying a funding amount expected to be received from the POS terminal; and confirm that funds received from the POS terminal match the funding amount expected. The computer-readable storage medium may further comprise instructions that, when executed, cause the processing device to authorize the POS terminal to accept the payment from the end-user. The settlement funding model may be selected from the group consisting of: a proactive funding model and a reactive funding model. The pricing model may be selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof.

### CONCLUSION

It is noted that the figures, individually and/or collectively, serve as embodiments of the presented systems and methods. Each individual process or sub-process performed within the embodiments described can be performed by one or more parties, as well as one or more computer systems. For example, in one embodiment, some or all of the communications and data transfers between merchant, service provider, and POS terminal are performed via an automated computer-based system, such as an application program interface. Further, not all of the individual process or sub-process described are necessary for implementing the systems and methods described herein. As such, the embodiments presented in the figures are not intended to be limiting.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. Further, each system component and/or method step presented should be considered a “means for” or “step for” performing the function described for said system component and/or method step. As such, any claim language directed to a “means for” or “step for” performing a recited function refers to the system component and/or method step in the specification that performs the recited function, as well as equivalents thereof.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A computer-implemented method for facilitating a transaction between an end-user and a merchant-partner, wherein a point-of-sale (POS) terminal receives presentment of a payment from an end-user for the merchant-partner, the method comprising:
a service provider processing system
(a) providing the merchant-partner with an interface such that the merchant-partner can define a settlement funding model and a pricing model;
(b) staging a transaction between the merchant-partner and the end-user, wherein the staging of the transaction includes calculating a transaction price based on the pricing model;
(c) receiving presentment data from the POS terminal indicating that the end-user has presented, to the POS terminal, a payment for the merchant-partner;
(d) using the presentment data to confirm that the payment is in accordance with the staged transaction between the end-user and the merchant-partner; and
(e) generating an outbound cash-flow to the merchant-partner to settle the transaction based on the settlement funding model.

2. The computer-implemented method of claim 1, wherein the settlement funding model is selected from the group consisting of: a proactive funding model and a reactive funding model.

3. The computer-implemented method of claim 2, wherein if the merchant-partner selects a proactive funding model, the method further comprises:
after step (e), the service provider processing system
(f) creating a funding record identifying a funding amount expected to be received from the POS terminal; and
(g) confirming that funds received from the POS terminal match the funding amount expected from step (f).

4. The computer-implemented method of claim 2, wherein if the merchant-partner selects a proactive funding model, the method further comprises:
in step (a), the service provider processing system
providing an interface such that the merchant-partner can define a settlement schedule;
in step (b), the service provider processing system
including the settlement schedule as a data field in the staged transaction; and
the service provider processing system performing step (e) on the settlement schedule.

5. The computer-implemented method of claim 2, wherein if the merchant-partner selects a reactive funding model, the method further comprises:
after step (d), but prior to step (e), the service provider processing system
(1) creating a funding record identifying a funding amount expected to be received from the POS terminal; and
(2) confirming that funds received from the POS terminal match the funding amount expected from step (1).

6. The computer-implemented method of claim 1, wherein the pricing model is selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof.

7. The computer-implemented method of claim 1, further comprising:
after step (d), but prior to step (e), the service provider processing system authorizing the POS terminal to accept the payment from the end-user.

8. A computer-readable storage medium, comprising:
instructions executable by at least one processing device that, when executed, cause the processing device to
(a) provide a merchant-partner with an interface such that the merchant-partner can set a settlement funding model and a pricing model;
(b) stage a transaction between the merchant-partner and an end-user, wherein the staging of the transaction includes calculating a transaction price based on the pricing model;
(c) receive presentment data from a POS terminal indicating that the end-user has presented, to the POS terminal, a payment for the merchant-partner;
(d) use the presentment data to confirm that the payment is in accordance with the staged transaction between the end-user and the merchant-partner; and
(e) generate an outbound cash-flow to the merchant-partner to settle the transaction based on the settlement funding model.

9. The computer-readable storage medium of claim 8, wherein the settlement funding model is selected from the group consisting of: a proactive funding model and a reactive funding model.

10. The computer-readable storage medium of claim 8, further comprising:
instructions executable by at least one processing device that, when executed, cause the processing device to
provide an interface such that the merchant-partner can set a settlement schedule; and
generate the outbound cash-flow in accordance with the settlement schedule.

11. The computer-readable storage medium of claim 8, further comprising:
instructions executable by at least one processing device that, when executed, cause the processing device to
(f) create a funding record identifying a funding amount expected to be received from the POS terminal; and
(g) confirm that funds received from the POS terminal match the funding amount expected.

12. The computer-readable storage medium of claim 8, wherein the pricing model is selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof.

13. The computer-readable storage medium of claim 8, further comprising:
instructions executable by at least one processing device that, when executed, cause the processing device to authorize the POS terminal to accept the payment from the end-user.

14. A computer-implemented system for facilitating a transaction between an end-user and a merchant-partner, wherein a point-of-sale (POS) terminal receives presentment of a payment from an end-user for the merchant-partner, the system comprising:
(a) means for providing the merchant-partner with an interface such that the merchant-partner can set a settlement funding model and a pricing model;
(b) means for staging a transaction between the merchant-partner and the end-user, wherein the staging of the transaction includes calculating a transaction price based on the pricing model;
(c) means for receiving presentment data from the POS terminal indicating that the end-user has presented, to the POS terminal, a payment for the merchant-partner;
(d) means for using the presentment data to confirm that the payment is in accordance with the staged transaction between the end-user and the merchant-partner; and
(e) means for generating an outbound cash-flow to the merchant-partner to settle the transaction based on the settlement funding model.

15. The system of claim 14, wherein the settlement funding model is selected from the group consisting of: a proactive funding model and a reactive funding model.

16. The system of claim 15, wherein if the merchant-partner selects a proactive funding model, the system further comprises:
means for providing an interface such that the merchant-partner can set a settlement schedule;
means for including the settlement schedule as a data field in the staged transaction; and
means for generating the outbound cash-flow in accordance with the settlement schedule.

17. The system of claim 14, further comprising:
(f) means for creating a funding record identifying a funding amount expected to be received from the POS terminal; and
(g) means for confirming that funds received from the POS terminal match the funding amount expected.

18. The system of claim 14, wherein the pricing model is selected from the group consisting of: a convenience fee pricing model, a variable commission pricing model, a fixed commission pricing model, a tiered convenience fee pricing model, a tiered variable commission pricing model, a tiered fixed commission pricing model, and any combination thereof.

19. The system of claim 14, further comprising:
means for authorizing the POS terminal to accept the payment from the end-user.

20. The system of claim 14, further comprising:
means for tokenizing the transaction.
